(19) United States
(12) Patent Application Publication
(10) Pub. No.: US 2021/0323319 A1
(43) Pub. Date: Oct. 21, 2021

(54) A PRINTING SYSTEM FOR PACKAGING MATERIAL

(71) Applicant: Tetra Laval Holdings & Finance S.A., Pully (CH)

(72) Inventors: Sverker Olsson, Södra Sandby (SE); Sylvain Debaecker, Eslöv (SE)

(21) Appl. No.: 16/490,387

(22) PCT Filed: Mar. 9, 2018
(86) PCT No.: PCT/EP2018/055947

§ 371 Date: Aug. 30, 2019

(30) Foreign Application Priority Data
Mar. 10, 2017 (EP) 17160418.4

(51) Int. Cl. B41J 11/00; B41J 3/54; B65B 61/02; B65B 3/02; B65B 41/18

(52) U.S. Cl. CPC B41J 11/008; B41J 3/543; B65B 41/18; B65B 3/025; B65B 61/025

(57) ABSTRACT

A printing system for providing a printed image (30) to a web (1) of packaging material (3) is provided. The printing system comprises a detecting unit (130) configured to detect a feature (10) on the packaging material (3), a control unit (120) configured to determine a first position of the detected feature (10), and a printing unit (110) having a plurality of printing nozzles (112). The control unit (120) is further configured to: determine a second position of an image (30) to be printed, the second position being determined based on the first position, determine at least one printing nozzle (112) based on the second position, and to activate the at least one printing nozzle (112) in order to print an image (30) onto the packaging material (3) at the second position.

### TECHNICAL FIELD

The invention relates to a printing system for packaging material. In particular the present invention relates to an adjustable printing system for printing images on a web of packaging material.

### BACKGROUND ART

In the packaging industry, especially for producing individual consumer packages for content such as liquid food, the packages are manufactured by forming and sealing a planar packaging material. The packaging material, which typically comprises a core layer of bulk material being covered on both sides by one or more polymer layers, is produced as a continuous web.

The filling machine receives one end of the web of the laminated packaging material and a plurality of stations provide the required processing of the packaging material in a continuous manner. Such stations may e.g. include feeding, sterilization, tube forming, filling, sealing and cutting, and final forming in order to provide a flow of individual ready-to-use packages.

The web of packaging material is running at extremely high speed; machine speeds allowing for up to 40.000 packages per hour are commercially available. Also during lamination and production of the packaging material high speed are utilized, whereby the speed of the web is in the order of 400 m/min and above.

Manufacturing of the web, as well as transportation of the web through the filling machine, requires high, continuous precision position control. For example, manufacturing of the packaging material may include the step of providing folding crease lines, pre-cut holes, external devices such as caps or similar, and printed patterns such as register marks and décor. Especially the printing may be performed in separate steps, and the appearance of the final package will be dependent on the alignment of the different features. Uncontrolled variations in the continuous positioning of the packaging material during production in the converting factory or in the filling machine may induce various types of errors.

Hence it is not only desirable to provide high precision alignment between the pre-cut hole and the crease lines, but also to provide high precision alignment of a printed pattern or mark relative the crease lines, the pre-cut hole, as well as relative previous printed patterns. For the high-speed application mentioned above it is thus very difficult to achieve correct, continuous positioning of the printed pattern, especially if there is a sudden misalignment of the web of packaging material during operation.

### SUMMARY

It is an object of the invention to at least partly overcome one or more of the above-identified limitations of the prior art. In particular, it is an object to improve the continuous positioning of printed images on a web of packaging material. Thus, while the substrate web is forwarded in a high speed manufacturing process, images or marks are printed onto the web surface, and the positioning of the printed images are continuously and dynamically adapted to any changes in the position of the substrate web during forwarding in the high speed process.

To solve these objects a printing system for providing a printed image to a web of packaging material is provided. The printing system comprises a detecting unit configured to continuously detect a feature on the packaging material, a control unit configured to continuously determine a first position of the detected feature, and a printing unit having a plurality of printing nozzles. The control unit is further configured to determine a second position of an image to be printed, the second position being determined based on the first position, determine at least one printing nozzle based on the second position, and to activate the at least one printing nozzle in order to print an image onto the packaging material at the second position.

The feature may be selected from the group comprising a lateral side edge of the web, a crease pattern, a pre-cut feature, an external device such as a cap, and a pre-printed pattern.

The printing detecting unit may be an optical detecting unit, such as an optical line scanner.

The printing unit may be a binary array printer.

The resolution of the printing unit may be 600 dpi (dot per inch) or above, such as 1200 dpi or above.

The printing unit may extend over at least a part of the total width of the web of packaging material, such as across the entire width, or only partly across the width, of the web of packaging material. The first position of the detected feature may be determined relative the position of the detecting unit, and/or relative the position of the printing unit.

According to a second aspect a method for providing a printed image to a web of packaging material is provided. The method comprises providing a detecting unit configured to detect a feature on the packaging material, providing a control unit configured to determine a first position of the detected feature, providing a printing unit having a plurality of printing nozzles, determining a second position of an image to be printed, the second position being determined based on the first position, determining at least one printing nozzle based on the second position, and activating the at least one printing nozzle in order to print an image onto the packaging material at the second position.

The printing system and the method may be applied either in the process of manufacturing of the packaging material or in the packaging process, i.e. the process of forming, filling and sealing of a packaging container, such as a carton-based packaging container, which is produced from a web or sheet of laminated packaging material and filled with liquid or semi-liquid food.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a top view of a packaging material forming a part of a web.

FIG. 2 schematically shows a method according to an embodiment.

FIG. 3 is a schematic view of a printing system according to an embodiment.

FIG. 4 is a schematic view of a printing device for use with the printing system shown in FIG. 3.

FIG. 5a shows a first example of a printed image provided by the printing system shown in FIG. 3.

FIG. 5b shows a second example of a printed image provided by the printing system shown in FIG. 3.

FIG. 6a-b are schematic views of parts of a printing device.

FIG. 7 is a schematic view of a printing system according to another embodiment.

FIG. 8 is a schematic view of a method according to an embodiment.

### DETAILED DESCRIPTION

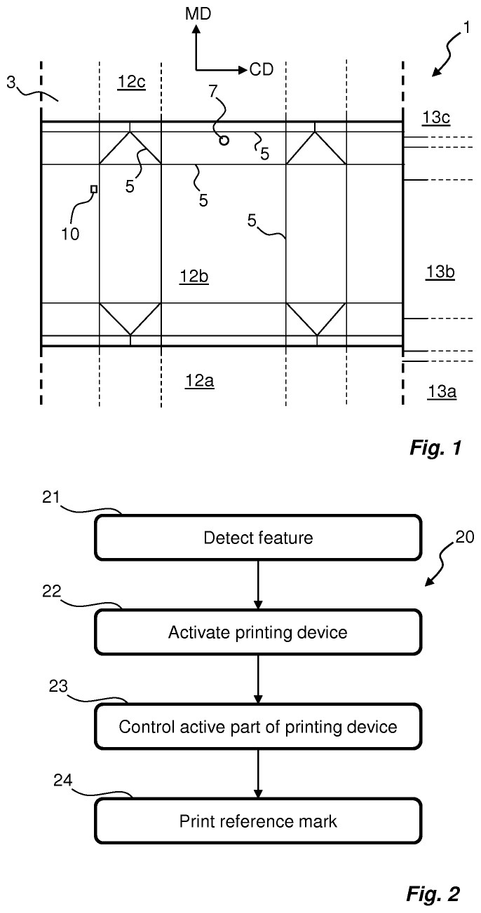

In FIG. 1 parts of a web 1 of a packaging material 3 is shown. The packaging material 3 is provided with several features for facilitating forming of individual packages. Such features may e.g. include crease lines 5, pre-laminated holes 7, and one or more printed images 30. As can be seen in FIG. 1 during manufacturing of the packaging material 3 the web 1 is dimensioned to accommodate several segments 12a-c, 13a-c, whereby each segment 12a-c, 13a-c is dimensioned to produce a single package. The segments 12a-f are arranged in sequence, both in lengthwise direction MD and cross-wise direction CD. Preferably the segments 12a-c, 13a-c are staggered in the cross-wise direction CD for reducing vibrations during creasing.

The printed image 30 may be provided for various purposes, as explained above. It may e.g. form a reference mark for future handling of the packaging material, or it may include some kind of information which may be read and used for traceability or authentication. In other cases the printed image 30 is part of the décor, i.e. it's only purpose is to contribute to the aesthetic appearance of the package to be formed.

The packaging material 3 is preferably manufactured in a converting facility, where a core layer of a paper-based material is laminated with one or more polymer layers on both sides. Typically the packaging material 3 comprises a core material layer, an outer layer, and an inner layer.

The outer layer applied to one side of the core material layer is adapted to provide the outer surface of the package to be produced, which outer surface and outer layer faces the surroundings of the package. The inner layer is applied to the other side of the core material layer and is adapted to provide the inner surface of the package to be produced which is in contact with the product contained in the package.

The core material may be a sheet for providing rigidity to the packaging material 3, and may preferably be made of material such as paper board or cardboard.

The outer layer may comprise at least one layer of polymer material, which is applied to the core material layer in a lamination process. Moreover, one of the layers making up the outer layer may be a decorative layer making up the outer appearance of the package to be formed. The process of laminating the outer layer to the core material layer is preferably performed after the image(s) 30 has been printed onto the packaging material 3.

The inner portion of the laminated packaging material, on the inner, opposite side of the core layer, may comprise at least one layer of polymer material. The inner portion of the packaging material intended for the inside of the finished package, may e.g. comprise (starting from the core material layer): a lamination layer, a protective layer such as an Aluminum foil, functioning as a barrier against gases, such as oxygen gas, and a sealing layer. The lamination layer enables the core material to stick to any protective layer applied, while the sealing layer enables package sealing.

The polymer layers of the packaging material 3 may be of any suitable type of polymer material, preferably a thermoplastic material such as a polyolefin, such as polyethylene.

Alternatively, the image(s) 30 is printed onto the packaging material 3 after the process of manufacturing of the laminated packaging material. Then the printing system may according to a further embodiment form a part of a filling and packaging machine, and the method of printing may be performed on the outermost layer of the packaging material web or sheet, i.e. on the side of the laminated material facing the outside environment of a packaging container, made from the packaging material.

Before describing details of the printing system used for providing printed images to the packaging material 3, a method 20 will be briefly described with reference to FIG. 2. When adding a printed image 30 to the packaging material 3 a number of subsequent steps are performed. Starting in step 21, the packaging material 3 is fed through the converting station and an optical reader is continuously scanning the surface of the web 1 in order to detect a pre-applied feature of the packaging material 3. Such feature may e.g. correspond to the lateral edge of the packaging material 3, a pre-laminated hole 7, a specific crease line 5, etc.

When the feature is detected, a printing unit is activated in step 22. The printing unit, comprising a plurality of printing nozzles arranged in an array extending in a direction being perpendicular to the feeding direction of the web 1 of packaging material 3, receives upon activation data relating to the intended position of the printed image as well as data relating to the content of the intended image. The intended position of the printed image is based on the position of the detected feature.

Controlling the printing unit, i.e. setting operation parameters in order to activate one or more of the multiple printing nozzles at specific times, is performed in step 23. In operation, i.e. when the printing unit is activated according to the set control scheme, the activated printing nozzles will discharge a printing substance, such as ink, onto the packaging material 3. Activation of the printing unit is preferably made in a pulse-wise manner, whereby a specific number of printing nozzles are activated during each pulse. As the web 1 of packaging material 3 is fed through the printing system each pulse will provide one line of the printed image, whereby the printed image grows in the feeding direction. Once printed, the printed image is readable by optical means such as a camera, a scanner, or human eyes.

This step of operating the printing unit to form subsequently printed lines onto the web 1 of packaging material 3 thus forms a step 24 of providing the printed image 10 onto the packaging material 3.

It should be noted that identification of variations in the placement or position of the reference feature can be based on multiple measurements, and not only to the position of a single feature. Multiple and different image-to-feature distances will add at least two major advantages. Firstly, using several features for determining the correct position of the printed image will provide better accuracy as any error from a single reading can be reduced from multiple readings. Secondly, by measuring the position of several different features it is possible to register position variations for potentially any type of feature present on the packaging material, and to allocate the measured positions to a unique reference ID. Such information could thereby later be used by retrieving this information and to adapt the filling machine behavior (or any other manufacturing process depending on dimension properties of the packaging material) accordingly.

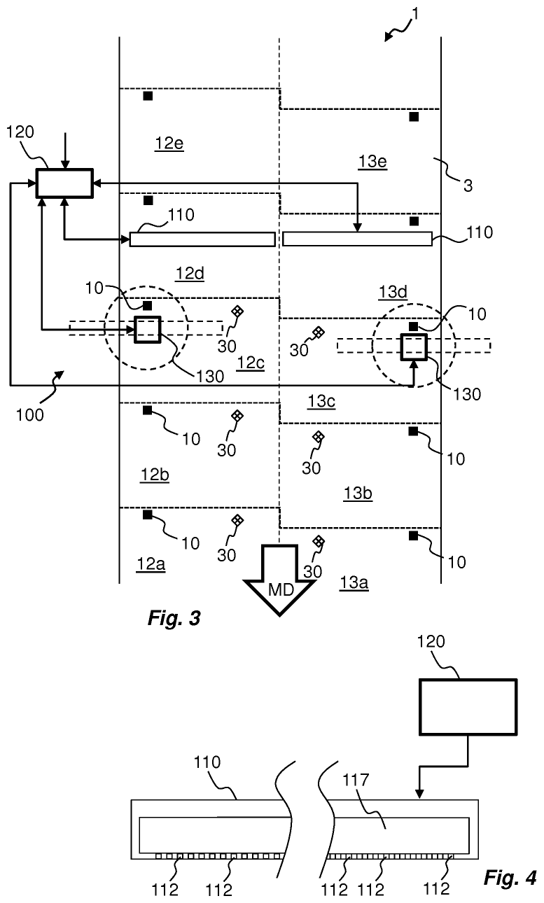

An example of a printing system 100 is shown in FIG. 3. As already explained with reference to FIG. 2 the printing system 100 is configured to operate in conjunction with a web 1 of packaging material 3, which is fed forward in a lengthwise direction MD, indicated by the arrow in FIG. 3. Importantly, this configuration allows the printing system 100 to fit with existing converting stations which typically converts a core material layer (such as a paper board or carton board) to a packaging material 3 by lamination. Preferably, the printing system 100 is provided upstream a lamination station used to provide the outer layer onto the core material layer.

The purpose of the printing system 100 is to provide one or more printed images 30 onto the packaging material 3. This is achieved by one or more printing units 110, each printing unit 110 being connected to a control unit 120.

Each printing unit 110 is arranged at a fixed position relative the surrounding equipment. This means that each printing unit 110 will have a fixed position, i.e. in the cross-wise direction, also relative the web 1 of packaging material 3 being fed through the printing system 100.

As can be seen in the example of FIG. 3 the web 1 of packaging material 3 is dimensioned so that the entire width of the web 1 corresponds to the required width for forming two packages. Segments 12a-e are longitudinally aligned, while segments 13a-e are longitudinally aligned and arranged adjacent to segments 12a-e. This configuration is applied for increasing the throughput during converting; before feeding the packaging material 3 to a filling machine, segments 13a-e are normally separated from segments 12a-e by a longitudinal cutting operation. As already explained, each segment 12a-e, 13a-e is designed to form one package.

As the web 1 of packaging material 3 travels forward, each printing unit 110 will be activated to provide the printed image 30 to the packaging material 3. For controlling the operation of the printing units 110, a control unit 120 is provided and connected to the printing units 110.

The control unit 120 is further connected to at least one optical detecting unit 130 being arranged facing the web 1 of packaging material 3 to detect one or more reference features 10. In the shown example the reference feature 10 is illustrated as a pre-printed mark, however as mentioned previously the reference feature 10 may correspond to the lateral edge of the web 1 of packaging material, a pre-laminated hole, a specific crease line, etc. Importantly, the reference feature 10 is required to be optically detectable by the detecting unit 130.

The detecting unit 130 may e.g. be implemented as a camera or a line scanner. The detecting unit 130 is not only configured to detect the presence of a feature 10, but also the position of the feature 10. For example, the position of the feature 10 may be determined using a virtual coordinate system in which the positions of the detecting unit 130 and the printing unit 110 are well-defined.

The control unit 120 thus receives a signal corresponding to the detected feature (or several different features), or optionally the control unit 120 itself determines the presence and position of the detected feature(s) 10 by analyzing the signal received from the detecting unit 130. The control unit 120 may further receive input relating to web speed. Based on the position of the reference feature 10 the control unit 120 is configured to control the operation of the printing unit 110 such that the printed image 30 has a correct position relative the reference feature 10.

Details of the printing unit 110 are shown in FIG. 4. In this example the printing unit 110 has a plurality of printing nozzles 112 coupled to at least one ink supply 117, each nozzle 112 being individually controllable by the control unit 120. It should be noted that only some of the nozzles 112 are provided with reference numerals. Each nozzle 112 is facing the web 1 of packaging material 3. The nozzles 112 are preferably arranged in a linear array, as shown in FIG. 4. The printing unit 110 preferably comprises several thousands of nozzles 112, wherein the distance between adjacent nozzles 112 is extremely small. For example, the resolution of the printing unit 110 may be 600 dots per inch or even higher, such as 1200 dpi or higher. This means that the distance between two adjacent nozzles is 40 microns or less.

Each nozzle 112 has a unique ID, and the position of each nozzle 112 is retrievable in the same coordinate system as used for determining the position of the reference feature 10. By determining the position of the reference feature 10, and knowing the desired position of the printed image 30, the control unit 120 is capable of activating the particular nozzles 112 being located relative the web 1 of packaging material 3 such that the actual printed image 30 will be provided at the desired position.

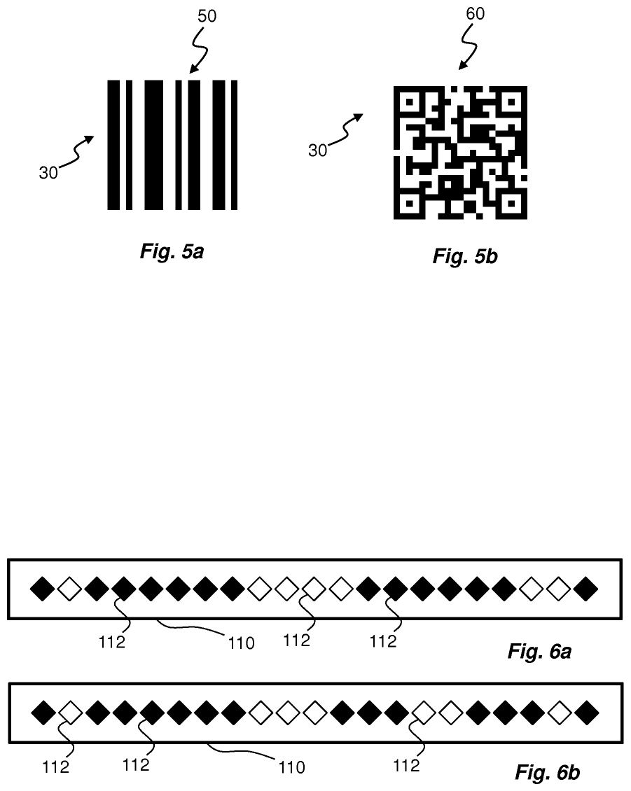

In FIGS. 5a and 5b two different examples of printed images 30 are shown. In FIG. 5a the printed 30 forms a bar code 50 which can be read by a suitable scanner. In FIG. 5b the printed image 30 is in the form of a 2D-code 60, such as a QR code or similar. For both examples the printed image 30 is square shaped, i.e. the resolution in cross-wise direction is equal to the resolution in lengthwise direction (X*X pixels). This is however not required. The cross-wise resolution is determined by the number of nozzles 112 being activated, while the lengthwise resolution is determined by the number of consecutive activation lines as the web 1 of packaging material 3 passes the printing unit 110. A printed image 30 can thus have other cross-wise extensions, whereby the limitation is set by the dimensions of the printing unit 110.

In FIGS. 6a and 6b an example of a control scheme for a printing unit 110 is shown. In these figures the nozzles 112 are shown as diamonds, and an active nozzle 112 is marked as black, i.e. a nozzle 112 currently ejecting ink. It should be noted that also in these figures only a few of the nozzles 112 are provided with reference numerals.

When the printing unit 110 is activated, i.e. when it is determined to provide a line of the printed image as a web 1 of packaging material 3 passes the printing unit 110, the control unit 120 controls the discharge of ink through the respective nozzles 112. Importantly, the nozzles 112 are individually controllable. In FIG. 6a fourteen nozzles are activated to discharge ink, while the remaining seven nozzles shown in the figure are inactive. Activation of a series of nozzles 112 represents one pulse. The pulse time may be extremely short, especially if the web 1 of packaging material 3 is running at high speeds. For example, in order to achieve a resolution of 600 dpi (dots per inch) also in the feeding direction on a web running at 400 m/min it would be required to set the pulse time to approximately 6 microseconds.

The next pulse will be emitted immediately after the first pulse, and the nozzles 112 are controlled accordingly. As can be seen in FIG. 6b for this pulse another set of nozzles 112 is activated to discharge ink onto the packaging material 3. By continuing emitting pulses the printed image 30 will grow in the lengthwise direction until the entire printed image 30 is provided onto the packaging material 3.

So far the printing system 100 has been described to provide printed images 30 at fixed positions on the packaging material 3. However, as will be understood from the following the printing system 100 can also be used to provide printed images at different positions, especially for ensuring the correct position of the printed image 30 relative other features 10 of the packaging material 3.

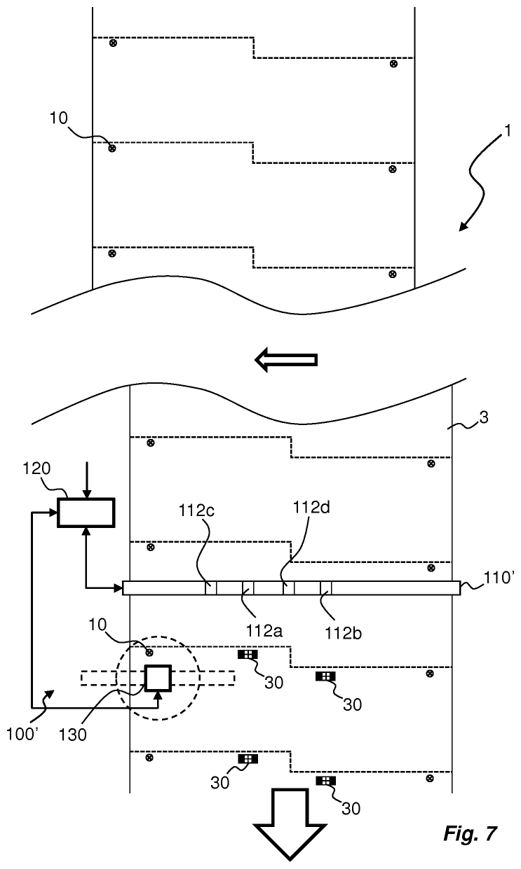

In FIG. 7 another example of a printing system 100′ is shown. The printing system 100′ comprises a printing unit 110′ extending across the entire width of the packaging material 3. As for the printing unit 110 described above a plurality of printing nozzles 112 are provided facing the moving packaging material 3, each nozzle being individually controllable by the control unit 120.

The packaging material 3 is provided with one or more reference features 10. The reference features 10 are provided to assist in correct positioning of the printed images 30. A detecting unit 130 is included in the printing system 100′ and detects the presence and position of the reference feature 10, especially the lateral or cross-wise position. The position of the detected reference feature 10 is transmitted to the control unit 120 which then associates the desired position of the image to be printed with the position of the reference feature 10. By also knowing the speed of the web 1 the control unit 120 may thus activate the relevant nozzles 112 such that the position of the printed image 30 will be correct both in lateral direction and feeding direction.

It should be noted that for a downstream portion of the web 1, one set of nozzles 112a is used for printing images 30 on the left portion of the web 1, while another set of nozzles 112b is used for printing images 30 on the right portion of the web 1. Within each set of nozzles 112a-b specific nozzles 112 are activated in a pulsed manner in order to form a growing image 30 as the web 1 moves forward.

As indicated in FIG. 7 the web 1 is shifted to the right after a certain time due to some manufacturing error occurring. When this shifting occurs the detecting unit 130 will detect another lateral position of the reference feature 10, whereby the control unit 120 will consequently determine new sets of outputs 112c-d of the printing unit 110′ so that the printed images 30 are located correctly relative the reference feature 10.

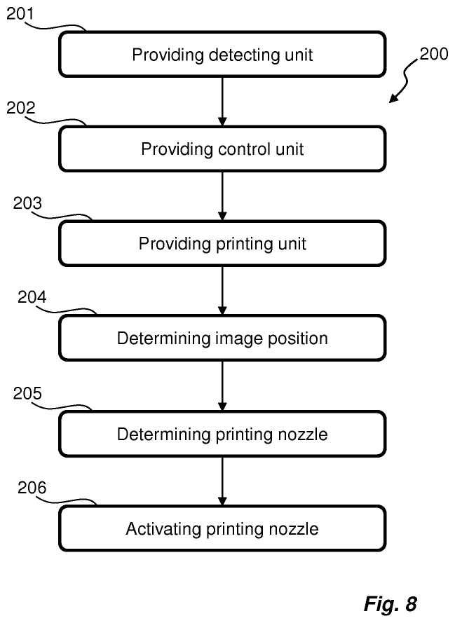

In FIG. 8 a schematic view of a method 200 is shown. The method 200 is performed to provide a printed image 30 to a web 1 of packaging material 3, and comprises the following. In 201, a detecting unit 130 configured to continuously detect a feature 10 on the packaging material 3 is provided. In 202, a control unit 120 configured to continuously determine a first position of the detected feature 10 is provided, and in 203 a printing unit 110 having a plurality of printing nozzles 112 is provided.

In 204 a second position of an image 30 to be printed is determined, the second position being determined based on the first position. In 205 at least one printing nozzle 112 is determined based on the second position, and in 206 at least one printing nozzle 112 is activated in order to print an image 30 onto the packaging material 3 at the second position.

From the description above follows that, although various embodiments of the invention have been described and shown, the invention is not restricted thereto, but may also be embodied in other ways within the scope of the subject-matter defined in the following claims.

1. A printing system for providing a printed image to a web of packaging material, the printing system comprising:
a detecting unit configured to detect a feature on the packaging material;
a control unit configured to determine a first position of the detected feature; and
a printing unit having a plurality of printing nozzles; wherein the control unit is further configured to:
determine a second position of an image to be printed on the packaging material, the second position being determined based on the first position of the detected feature;
determine at least one printing nozzle based on the second position of the image; and
activate the at least one determined printing nozzle in order to print the image onto the packaging material at the second position.

2. The printing system according to claim 1, wherein said feature is selected from the group consisting of a lateral side edge of the web, a crease pattern, a pre-cut feature, an external device, and a pre-printed pattern.

3. The printing system according to claim 1, wherein the detecting unit is an optical detecting unit.

4. The printing system according to claim 3, wherein the optical detecting unit is an optical line scanner.

5. The printing system according to claim 1, wherein the printing unit is a binary array printer.

6. The printing system according to claim 1, wherein a resolution of the printing unit is 600 dpi or above.

7. The printing system according to claim 1, wherein the printing unit extends only partly across a total width of the web of the packaging material.

8. The printing system according to claim 1, wherein the printing unit extends across an entire width of the web of the packaging material.

9. The printing system according to claim 1, wherein the first position of the detected feature is determined relative to a position of the detecting unit.

10. The printing system according to claim 1, wherein the first position of the detected feature is determined relative to a position of the printing unit.

11. A method for providing a printed image to a web of packaging material, the method comprising:
providing a detecting unit configured to detect a feature on the packaging material;
providing a control unit configured to determine a first position of the detected feature;
providing a printing unit having a plurality of printing nozzles;
determining a second position of an image to be printed on the packaging material, the second position being determined based on the first position of the detected feature;
determining at least one printing nozzle based on the second position of the image; and
activating the at least one printing nozzle in order to print the image onto the packaging material at the second position.

12. The printing system according to claim 2, wherein said external device is a cap.

13. The printing system according to claim 6, wherein said resolution of the printing unit is 1200 dpi or above.
